(19) United States
(12) Patent Application Publication
(10) Pub. No.: US 2025/0329147 A1
(43) Pub. Date: Oct. 23, 2025

(54) DIVERSITY USING ADVERSARIALLY LEARNED TRANSFORMATIONS FOR DOMAIN GENERALIZATION

(71) Applicants: Arizona Board of Regents on Behalf of Arizona State University, Scottsdale, AZ (US); Lawrence Livermore National Security, LLC, Livermore, CA (US)

(72) Inventors: Tejas Gokhale, Columbia, MD (US); Rushil Anirudh, San Francisco, CA (US); Jayaraman Thiagarajan, Milpitas, CA (US); Bhavya Kailkhura, Round Rock, TX (US); Chitta Baral, Gilbert, AZ (US); Yezhou Yang, Phoenix, AZ (US)

(21) Appl. No.: 18/674,001

(22) Filed: May 24, 2024

Related U.S. Application Data
(60) Provisional application No. 63/468,653, filed on May 24, 2023.

(51) Int. Cl. G06V 10/774; G06V 10/764; G06V 10/776; G06V 10/82

(52) U.S. Cl. CPC G06V 10/7747; G06V 10/764; G06V 10/776; G06V 10/82

(57) ABSTRACT

An ALT framework (Adversarially Learned Transformations framework) may be trained to learn multiple target generalizations from a single source domain utilizing a diversity network, an adversary network, and a classifier. ALT framework may obtain an image training dataset and generate image perturbations parameterized by the adversarial network as learnable weights of a neural network representing learned image transformations by the adversarial network for the plurality of input images. Processing circuitry may train an Artificial Intelligence model (AI model) of ALT framework to learn generalizations for the single source domain from the plurality of input images of the image training dataset and the learnable weights of the neural network representing the learned image transformations by the adversarial network. Processing circuitry may train the AI model of the ALT framework to learn the multiple target generalizations from supplemental images generated by the adversarial network and output the AI model.

### CLAIM OF PRIORITY

This application claims the benefit of U.S. Patent Application No. 63/468,653, filed 24 May 2023, the entire contents of which is incorporated herein by reference.

### GOVERNMENT RIGHTS AND GOVERNMENT AGENCY SUPPORT NOTICE

This invention was made with government support under 1816039 and 2132724 awarded by the National Science Foundation. The government has certain rights in the invention.

This invention was made with Government support under DE-AC52-07NA27344 awarded by the United States Department of Energy. The Government has certain rights in the invention.

### TECHNICAL FIELD

This disclosure generally relates to the field of artificial intelligence and machine learning via computational systems and more particularly, to systems, methods, and apparatuses for improving diversity using adversarially learned transformations for domain generalization.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

Machine learning models have various applications to automatically process inputs and produce outputs considering situational factors and learned information to improve output quality. One area where machine learning models, and neural networks in particular, provide high utility is in the field of image processing.

Within the context of machine learning and with regard to deep learning specifically, a Convolutional Neural Network (CNN, or ConvNet) is a class of deep neural networks, very often applied to analyzing visual imagery. Convolutional Neural Networks are regularized versions of multilayer perceptrons. Multilayer perceptrons are fully connected networks, such that each neuron in one layer is connected to all neurons in the next layer, a characteristic which often leads to a problem of overfitting of the data and the need for model regularization. Convolutional Neural Networks also seek to apply model regularization, but with a distinct approach. Specifically, CNNs take advantage of the hierarchical pattern in data and assemble more complex patterns using smaller and simpler patterns. Consequently, on the scale of connectedness and complexity, CNNs are on the lower extreme.

### SUMMARY

In general, this disclosure is directed to improved diversity using adversarially learned transformations for domain generalization.

Increasing the diversity of synthesized domains has emerged as one of the most effective strategies in single source domain generalization (SSDG). Recent improvements in SSDG are correlated with methodologies that pre-specify diversity inducing image augmentations during training, enabling the trained models to provide better generalization on new domains. However, naïve pre-specified augmentations may not be adequate, either because they cannot model large domain shifts, or because the specific choice of transforms may not cover the types of shift commonly occurring in domain generalization.

To address this issue, a novel framework enabling Adversarially Learned Transformations (ALT) is described herein that utilizes an adversary neural network to model plausible, yet hard image transformations that fool classifiers. The ALT framework learns image transformations by randomly initializing the adversary network for each batch and optimizing the adversary network for a fixed number of steps to increase classification error. A classifier of the ALT framework may be trained by enforcing a consistency between predictions output by classifier on the clean and transformed images. With extensive empirical analysis, this new form of adversarial transformations was found to achieve both objectives of diversity and hardness simultaneously, outperforming all existing techniques on competitive benchmarks for SSDG. Moreover, the ALT framework is demonstrated to seamlessly work with existing diversity networks to produce highly distinct, and large transformations of the source domain leading to state-of-the-art performance.

Prior known techniques fail to produce adequate diversity which are sufficient to adapt to a domain shift or provide necessary generalization from the training dataset.

What is needed is a technique for improving diversity and increasing applicability of the trained models through greater generalization.

The present state of the art may therefore benefit from the systems, methods, and apparatuses for implementing improved diversity using adversarially learned transformations for domain generalization as applied by the ALT framework, as is described herein.

In at least one example, one or more processors of a computing device are configured to perform a computer-implemented method. Such a method may include processing circuitry executing an Adversarially Learned Transformations framework (ALT framework) to learn multiple target generalizations from a single source domain, the ALT framework having at least a diversity network, an adversary network, and a classifier. In such examples, processing circuitry may obtain an image training dataset having a plurality of input images representing the single source domain and generate, utilizing the AFT framework, image perturbations parameterized by the adversarial network as learnable weights of a neural network representing learned image transformations by the adversarial network for the plurality of input images. According to such an example, processing circuitry may train an Artificial Intelligence model (AI model) of the AFT framework to learn generalizations for the single source domain from the plurality of input images of the image training dataset and the learnable weights of the neural network representing the learned image transformations by the adversarial network. Processing circuitry may train the AI model of the AFT framework to learn the multiple target generalizations from supplemental images generated by the adversarial network and output the AI model.

In at least one example, a system includes processing circuitry; non-transitory computer readable media; and instructions that, when executed by the processing circuitry, configure the processing circuitry to perform operations. In such an example, processing circuitry may configure the system to execute an ALT framework to learn multiple target generalizations from a single source domain, the ALT framework having at least a diversity network, an adversary network, and a classifier. In such examples, processing circuitry may obtain an image training dataset having a plurality of input images representing the single source domain and generate, utilizing the AFT framework, image perturbations parameterized by the adversarial network as learnable weights of a neural network representing learned image transformations by the adversarial network for the plurality of input images. According to such an example, processing circuitry may train an Artificial Intelligence model (AI model) of the AFT framework to learn generalizations for the single source domain from the plurality of input images of the image training dataset and the learnable weights of the neural network representing the learned image transformations by the adversarial network. Processing circuitry may train the AI model of the AFT framework to learn the multiple target generalizations from supplemental images generated by the adversarial network and output the AI model.

In one example, there is computer-readable storage media having instructions that, when executed, configure processing circuitry to perform operations. Such operations may include executing an ALT framework to learn multiple target generalizations from a single source domain, the ALT framework having at least a diversity network, an adversary network, and a classifier. In such examples, operations may obtain an image training dataset having a plurality of input images representing the single source domain and generate, utilizing the AFT framework, image perturbations parameterized by the adversarial network as learnable weights of a neural network representing learned image transformations by the adversarial network for the plurality of input images. According to such an example, operations may train an Artificial Intelligence model (AI model) of the AFT framework to learn generalizations for the single source domain from the plurality of input images of the image training dataset and the learnable weights of the neural network representing the learned image transformations by the adversarial network. Operations may train the AI model of the AFT framework to learn the multiple target generalizations from supplemental images generated by the adversarial network and output the AI model.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of computing device, in accordance with aspects of this disclosure.

FIG. 2 depicts an overview of a framework for identifying Adversarially Learned Transformations (ALT), in accordance with aspects of the disclosure.

FIG. 3 illustrates a plot summarizing ALT framework results, in accordance with aspects of the disclosure.

FIG. 4 depicts Algorithm 1, providing pseudo code for applying adaptive diversity via ALT, in accordance with aspects of the disclosure.

FIG. 5 depicts Table 1, illustrating single-source domain generalization accuracy (%) on PACS, in accordance with aspects of the disclosure.

FIG. 6 depicts Table 2, illustrating single-source domain generalization accuracy (%) on Office-Home, in accordance with aspects of the disclosure.

FIG. 7 depicts Table 3, illustrating single-source domain generalization accuracy (%) on digit classification, with MNIST-10K as a source domain and MNIST-M, SVHN, USPS, and SYNTH as target domains, in accordance with aspects of the disclosure.

FIG. 8A illustrates a tSNE plot showing the discrepancy between the source distribution (MNIST) and the target Out-Of-Distribution (OOD) datasets for the “Digits” benchmark, in accordance with aspects of the disclosure.

FIG. 8B provides a qualitative comparison of PACS images transformed by RandConv (r) data augmentation vs. ALT framework (ALT_{RandConv}), illustrating the wide range of transformations learned by ALT framework, in accordance with aspects of the disclosure.

FIGS. 9A, 9B, and 9C provide analysis depicting the effect of each hyper-parameter in ALT framework on the average accuracy using the Digits benchmark, in accordance with aspects of the disclosure.

FIG. 10 is a flow chart illustrating an example mode of operation for a computing device to improve diversity using adversarially learned transformations for domain generalization, in accordance with aspects of the disclosure.

Like reference characters denote like elements throughout the text and figures.

### DETAILED DESCRIPTION

Aspects of the disclosure provide improved diversity using adversarially learned transformations for domain generalization.

Domain generalization is the problem of making accurate predictions on previously unseen domains, especially when these domains are very different from the data distribution on which the model was trained. This is a challenging problem that has seen steady progress over the last few years. Application of the novel Adversarially Learned Transformations (ALT) framework as described herein addresses the problem of single source domain generalization (SSDG). For instance, the ALT framework operates even where a trained artificial intelligence (AI) model of the ALT framework has access only to a single training domain, and yet, is expected to generalize to multiple different testing domains.

The problem of SSDG (e.g., generalizing to multiple different testing domains from a single source) is especially difficult to overcome because of the limited information available via which to train an AI model using only a single source. When multiple source domains are available, known as Multiple Source Domain Generalization (MSDG), analysis shows that even simple methods like minimizing empirical risk jointly on all domains, performs better than most existing sophisticated formulations. A corollary to this finding is that success in Domain Generalization (DG) is dependent on diversity—e.g., exposing the AI model to as many potential training domains as possible.

As the SSDG problem allows access only to a single training domain, such an exposure must come in the form of diverse transformations of the source domain that may simulate the presence of multiple domains, ultimately leading to low generalization error. Experiments using diversity to train models demonstrate that a diverse set of augmentations during training improves robustness of an AI model under distribution shifts. Specific augmentations may be used if the type of diversity encountered at test time is known. For instance, when it is known that the test set contains random combinations of rotation, translation, and scaling, using augmentations correlated with this domain shift leads to good performance.

However, since one cannot assume knowledge of the test domain under SSDG problem conditions, the extent to which an AI model needs to be exposed to specific augmentations remains unclear. Augmentation methods impose a strong prior in terms of the types of diversity that the model is exposed to, which may not match with desirable test-time transformations.

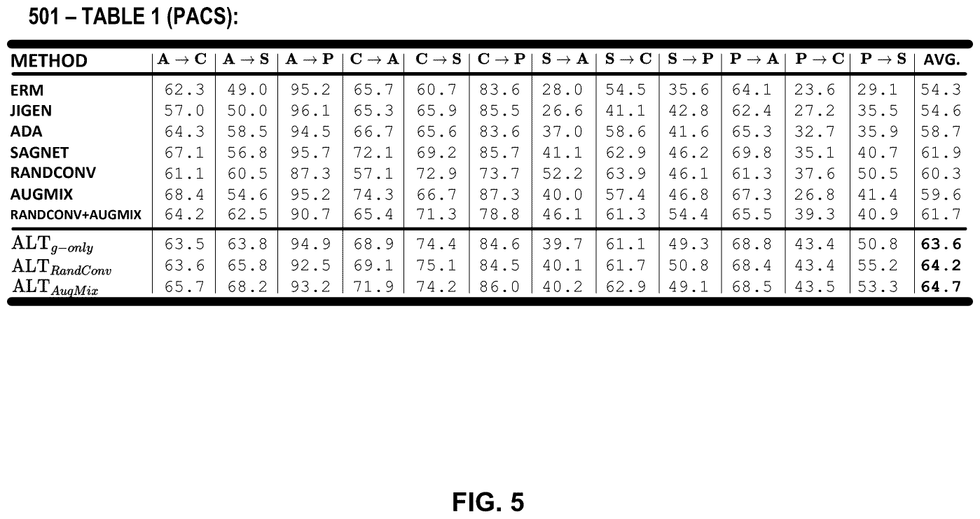

As shown by the results described below in relation to FIGS. 5, 6, and 7 (refer to Tables 1, 2 and 3), data augmentation methods that produce good results on one dataset, do not necessarily work on other datasets. Indeed, data augmentation methods that produce good results on one dataset may, in some cases, degrade performance.

In addition to the existence of such a knowledge gap, augmentation methods may achieve invariance under small distribution shifts like unknown corruptions, noise, or adversarial perturbations, but may not work effectively when the distribution shift is large and of a semantic nature, as in the case of domain generalization. Conversely, some techniques have directly used randomized convolutions to synthesize diverse image manipulations, motivated by the large space of potentially realizable functions induced by a convolutional layer, which cannot be easily emulated using simple analytical functions.

While diversity is necessary for single-source domain generalization, diversity alone is insufficient. Blindly exposing a model to a wide range of transformations may not guarantee greater generalization. Instead, carefully designed forms of diversity may improve generalization from a single source domain. Specifically, forms of diversity that may expose the model to unique and task-dependent transformations with large semantic changes that are otherwise unrealizable with plug-and-play augmentations.

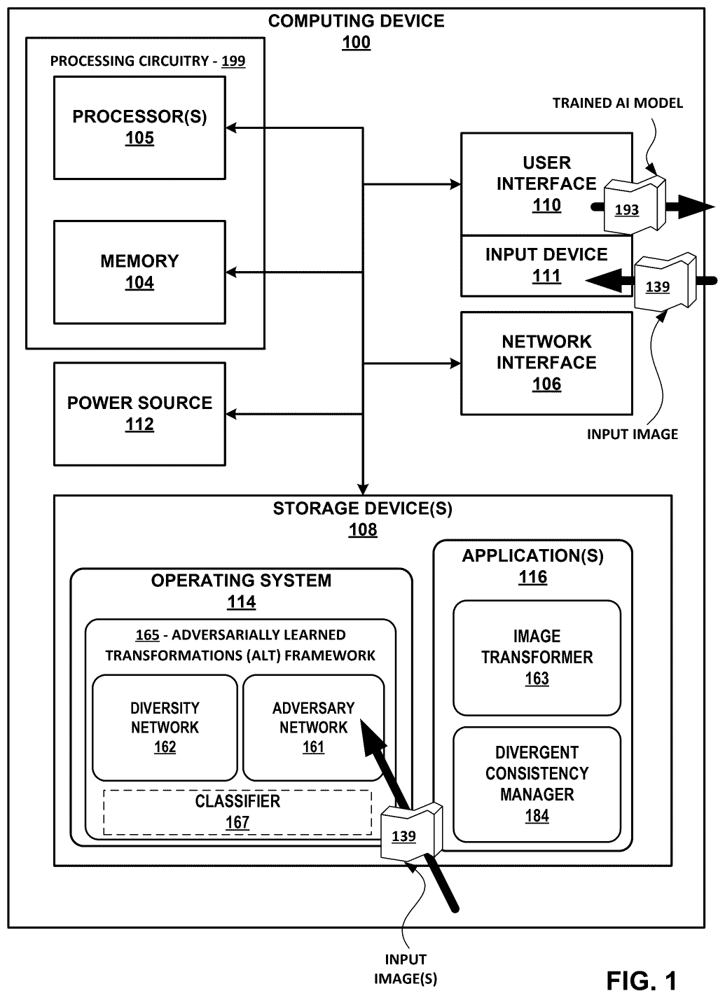

FIG. 1 is a block diagram illustrating further details of one example of computing device, in accordance with aspects of this disclosure. FIG. 1 illustrates only one particular example of computing device 100. Many other example embodiments of computing device 100 may be used in other instances.

As shown in the specific example of FIG. 1, computing device 100 may include processing circuitry 199 including one or more processors 105 and memory 104. Computing device 100 may further include network interface 106, one or more storage devices 108, user interface 110, and power source 112. Computing device 100 may also include an operating system 114. Computing device 100, in one example, may further include one or more applications 116, such as image transformer 163 and divergent consistency manager 184. One or more other applications 116 may also be executable by computing device 100. Components of computing device 100 may be interconnected (physically, communicatively, and/or operatively) for inter-component communications.

Operating system 114 may execute various functions including executing trained AI model 193 and performing AI model training. As shown here, operating system 114 executes Adversarially learned transformations (ALT) framework 165 which includes both diversity network 161 and adversary network 162 components. Both diversity network 161 and adversary network 162 may receive input image(s) 139 as input obtained from input device 111 or other sources for use as training images within a training dataset. ALT framework 165 further includes classifier 167 which is configured to output a prediction classifying an evaluated input image 139 and/or transformed image as provided by adversary network 162.

Computing device 100 may perform techniques for implementing improved diversity using adversarially learned transformations for domain generalization, including performing AI model training using a training image dataset including, for example, input image 139 by learning generalizations from input images 139 of a single source domain and increasing learned generalizations for multiple target domains based on transformed images provided by image transformer 163. ALT framework 165 may enforce joint consistency via divergent consistency manager 184. Computing device 100 may provide trained AI model 193 as output to a connected user device via user interface 110.

In some examples, processing circuitry including one or more processors 105, implements functionality and/or process instructions for execution within computing device 100. For example, one or more processors 105 may be capable of processing instructions stored in memory 104 and/or instructions stored on one or more storage devices 108.

Memory 104, in one example, may store information within computing device 100 during operation. Memory 104, in some examples, may represent a computer-readable storage medium. In some examples, memory 104 may be a temporary memory, meaning that a primary purpose of memory 104 may not be long-term storage. Memory 104, in some examples, may be described as a volatile memory, meaning that memory 104 may not maintain stored contents when computing device 100 is turned off. Examples of volatile memories may include random access memories (RAM), dynamic random-access memories (DRAM), static random-access memories (SRAM), and other forms of volatile memories. In some examples, memory 104 may be used to store program instructions for execution by one or more processors 105. Memory 104, in one example, may be used by software or applications running on computing device 100 (e.g., one or more applications 116) to temporarily store data and/or instructions during program execution.

One or more storage devices 108, in some examples, may also include one or more computer-readable storage media. One or more storage devices 108 may be configured to store larger amounts of information than memory 104. One or more storage devices 108 may further be configured for long-term storage of information. In some examples, one or more storage devices 108 may include non-volatile storage elements. Examples of such non-volatile storage elements may include magnetic hard disks, optical discs, floppy disks, Flash memories, or forms of electrically programmable memories (EPROM) or electrically erasable and programmable (EEPROM) memories.

Computing device 100, in some examples, may also include a network interface 106. Computing device 100, in such examples, may use network interface 106 to communicate with external devices via one or more networks, such as one or more wired or wireless networks. Network interface 106 may be a network interface card, such as an Ethernet card, an optical transceiver, a radio frequency transceiver, a cellular transceiver or cellular radio, or any other type of device that can send and receive information. Other examples of such network interfaces may include BLUETOOTH®, 3G, 4G, 1G, LTE, and WI-FI® radios in mobile computing devices as well as USB. In some examples, computing device 100 may use network interface 106 to wirelessly communicate with an external device such as a server, mobile phone, or other networked computing device.

User interface 110 may include one or more input devices 111, such as a touch-sensitive display. Input device 111, in some examples, may be configured to receive input from a user through tactile, electromagnetic, audio, and/or video feedback. Examples of input device 111 may include a touch-sensitive display, mouse, keyboard, voice responsive system, video camera, microphone or any other type of device for detecting gestures by a user. In some examples, a touch-sensitive display may include a presence-sensitive screen.

User interface 110 may also include one or more output devices, such as a display screen of a computing device or a touch-sensitive display, including a touch-sensitive display of a mobile computing device. One or more output devices, in some examples, may be configured to provide output to a user using tactile, audio, or video stimuli. One or more output devices, in one example, may include a display, sound card, a video graphics adapter card, or any other type of device for converting a signal into an appropriate form understandable to humans or machines. Additional examples of one or more output devices may include a speaker, a cathode ray tube (CRT) monitor, a liquid crystal display (LCD), or any other type of device that can generate intelligible output to a user.

Computing device 100, in some examples, may include power source 112, which may be rechargeable and provide power to computing device 100. Power source 112, in some examples, may be a battery made from nickel-cadmium, lithium-ion, or other suitable material.

Examples of computing device 100 may include operating system 114. Operating system 114 may be stored in one or more storage devices 108 and may control the operation of components of computing device 100. For example, operating system 114 may facilitate the interaction of one or more applications 116 with hardware components of computing device 100.

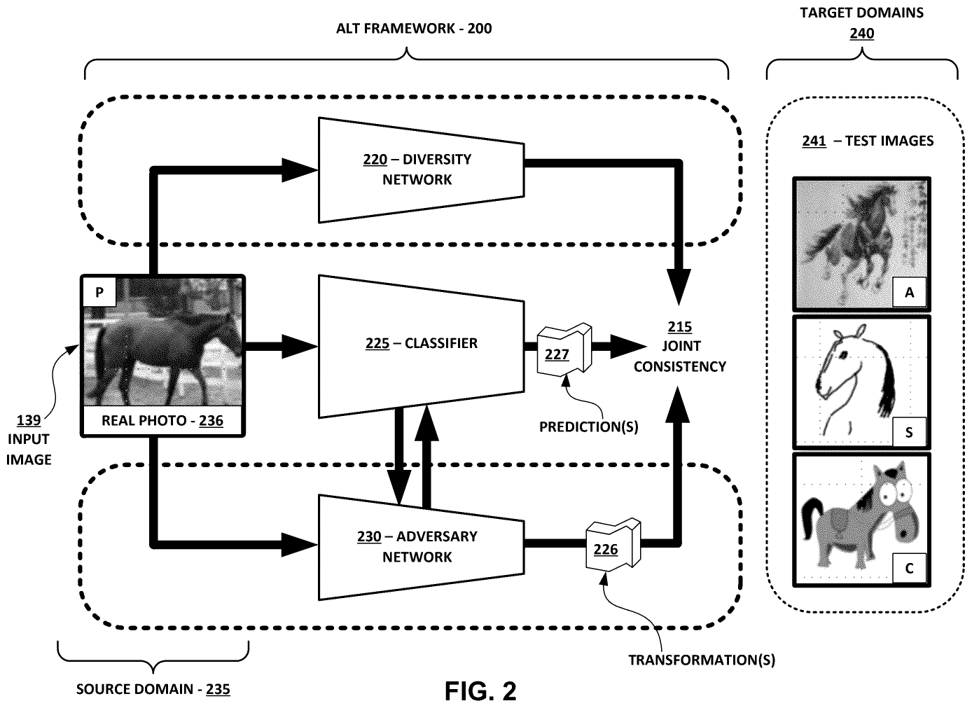

FIG. 2 depicts an overview of a framework for identifying Adversarially Learned Transformations (ALT), in accordance with aspects of the disclosure.

The described methodology, referred to herein as adversarially learned transformations or “ALT” as applied by ALT framework 200, offers an interplay between diversity and adversity. ALT framework 200 is enabled to find plausible image transformations that increase classification error. Adversary network 230 of ALT framework 200 enables access to a much richer family of image transformations as compared to prior known techniques for data augmentation. ALT framework 200 may randomly initialize adversary network 230 in each iteration, ensuring adversarial transformations 226 are unique and diverse themselves.

As shown here, ALT framework 200 includes diversity network 220 for performing data augmentation functions such as AugMix (utilizes stochasticity and diverse augmentations, divergence consistency loss, and a formulation to mix multiple augmented images) or Random Convolutions (RandConv), and adversary network 230 enabling ALT framework to learn image transformations that fool classifier 225.

An example is shown from the Picture Archiving and Communication Systems (PACS) benchmark under the single-source domain generalization (SSDG) setting, with real photos (P) 236 as the source domain 235 and test images 241 including art paintings (A), cartoons (C), and sketches (S) as the target domains 240. In particular, an image of a horse is shown from the real photograph 236 training distribution in PACS and the different styles of cartoon/sketch/art painting horses that may be encountered from within the set of test images 241 at test time.

Joint consistency 215 between diversity network 220 and adversary network 230 may be enforced by ALT framework 200 during training along with predictions 227 output by classifier 225, so that together they expose ALT framework 200 model to learn from both diverse and challenging domains. Over time, a synergistic partnership between diversity network 220 and adversary network 230 emerges, exposing ALT framework 200 model to increasingly unique, challenging and semantically diverse examples that are ideally suited for single source domain generalization.

Adversary network 230 within ALT framework 200 benefits from classifier 225 being exposed to diversity network 220, enabling ALT framework 200 to avoid trivial adversarial samples with appropriate checks. This approach enables the adversarial maximization function of ALT framework 200 to explore a wider space of adversarial transformations 226 that may not be otherwise covered utilizing techniques such as pixel-level additive perturbations.

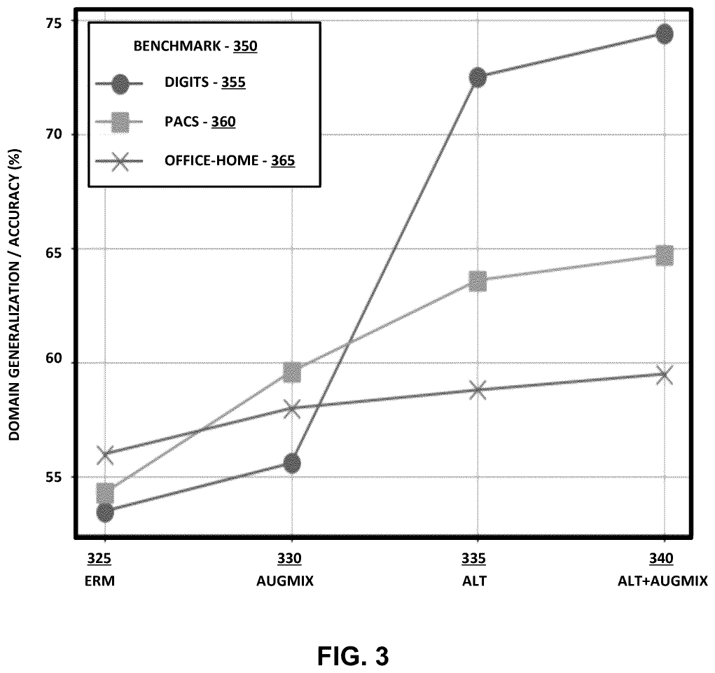

FIG. 3 illustrates a plot summarizing ALT framework 200 results, in accordance with aspects of the disclosure.

In particular, several benchmarks 350 including Digits 355, PACS 360, and Office-Home 365 are plotted for domain generalization/accuracy (%) on the vertical axis against each of the techniques on the horizontal axis, including Expected Risk Minimization (ERM) 325, AugMix 330, ALT 335, and ALT+AugMix 340. Each of ALT 335 and ALT+AugMix 340 are applied to the benchmarks 350 by ALT framework 200.

While diversity alone improves performance over the naive ERM 325 baseline technique, adapting this diversity using adversarially learned transformations (ALT 335) provides a significant boost for domain generalization on multiple benchmarks 350.

Advantages of ALT framework 200 are demonstrated empirically on the multiple benchmarking 350 platforms, including: PACS 360, Office-Home 365, and Digits 355. On each benchmarking 350 platform, ALT framework 200 outperformed prior known state-of-the-art single source domain generalization methods by a significant margin as depicted by the domain generalization intersect with ALT 335. Moreover, since ALT framework 200 disentangles diversity network 220 and adversarial network 230 modules, ALT 335 may be combined by the ALT framework 200 with various diversity enforcing techniques. For instance, ALT 335 may be combined with state-of-the-art methods AugMix, and RandConv. The domain generalization intersecting with ALT+AugMix 340 depicts such a combination. The results discussed below in relation to FIGS. 5, 6, and 7 (refer to Tables 1, 2 and 3) show that placing AugMix, and RandConv inside ALT framework 200 leads to significantly improved generalization performance over their vanilla counterparts.

In such a way, utilization of ALT framework 200 provides at least the following benefits over all prior known techniques: ALT framework 200 applies a methodology which produces adversarially learned image transformations 226 that expose classifier 225 to a large space of image transformations 226 for superior domain generalization performance. ALT framework 200 enables adversarial training in the parameter space of adversary network 230 as opposed to pixel-level adversarial training. ALT framework 200 integrates diversity-inducing data augmentation and hardness-inducing adversarial training in a synergistic pipeline, leading to diverse transformations 226 that cannot be realized by blind augmentation strategies or adversarial training methods on their own. ALT framework 200 was experimentally validated and the applied methodology is empirically shown to be superior on three distinct benchmarks, including PACS, Office-Home, and Digits. The benchmarking results showing state-of-the-art performance are provided below with additional analysis of ALT framework 200.

Multi-Source Domain Generalization: Domain generalization has been explored under both multi-source domain generalization (MSDG) and single-source domain generalization (SSDG) setting. For the MSDG task, multiple source domains were available for training and performance was evaluated on other unseen target domains. Techniques designed for MSDG utilize these multiple domains to perform feature fusion, learning domain-invariant features, meta-learning, invariant risk minimization, learning mappings between multiple training domains, style randomization, and learning a conditional generator. The learned conditional generator synthesizes novel domains using cycle-consistency in which simply performing ERM on the combination of source domains leads to the best performance.

Many benchmarks have been proposed to evaluate MSDG performance such as PACS, Office-Home, Digits, and WILDS which is a compendium of MSDG datasets.

Single-Source Domain Generalization: Setting only one domain to be available for training on the respective benchmarks, SSDG is significantly more difficult due to the lack of MSDG methods. Whether due to artificial constraints or a lack of real-world source domain data SSDG presents significant challenges to AI model training.

Prior known solutions have addressed this deficit through data augmentation. Notable among such approaches is the idea of adversarial data augmentation (ADA) and Meta-Learning based Adversarial Domain Augmentation (M-ADA). Techniques including ADA and M-ADA apply pixel-level additive perturbations to the image in order to fool classifier 225. The perturbed images that successfully fool classifier 225 are then used as augmented data to train classifier 225. RandConv shows that shape-preserving transformations in the form of random convolutions of images may lead to impressive performance gains on the Digits benchmarking platform.

Adversarial Attack and Defense: Adversarial attack algorithms have been developed to successfully fool image classifiers 225 via pixelwise perturbations and defensive algorithms have been developed to defend against such adversarial attacks. Rather than performing adversarial attack and defense algorithms, ALT framework 200 provides the framework to obtain adversarially generated samples that improve domain generalization performance.

Adversarial Training: Using ALT framework 200, the described methodology emphasizes the nature of the diversity that may be acquired during training in support of improving performance within single-source applications. ALT framework 200 may learn adversarial perturbations in the function space of neural network weights. This enables ALT framework 200 access to a wider and richer space of augmentations compared to pixel-wise perturbations such as ADA and M-ADA, or combinatorial augmentation search methods such as Exploratory Spatial Data Analysis (ESDA). The adversarial network 230 component in ALT framework 200 allows adversarial network 230 to seek newer and harder transformations 226 for every batch as training progresses, which cannot be achieved with static augmentations such as AugMix or RandConv, or by utilizing normalization layer statistics for style debiasing.

Robustness to Image Corruptions: There has also been interest in training classifiers 225 that are robust to corruptions that occur in the real world, such as different types of noise and blur, artifacts due to compression techniques, and weather-related environments such as fog, rain, and snow. Training models with corruption augmentations may not guarantee robustness to other unseen types of corruption or different levels of corruption severity. Curated benchmarks such as ImageNet-C and CIFAR-C have been used to test robustness along a fixed set of corruptions. Another benchmark, called ImageNet-P, tests robustness against other corruption types such as small tilts and changes in brightness. A similar benchmark for corruptions of handwritten digit images, MNIST-C, has also been made available.

Data Augmentation: has been an effective strategy for improving in-domain generalization using simple techniques such as random cropping, horizontal flipping, occlusion or removal of patches. Data augmentation techniques have been shown to improve robustness against adversarial attacks and natural image corruptions. Learning to augment data has been explored in the context of object detection and image classification.

### Methodology:

Assuming single-source domain generalization settings, consider the training dataset [symbol] containing N image-label pairs

$$𝒟 = {\{ ( {x}_{i} , {y}_{i} ) \}}_{i = 1}^{N} ,$$

and a classifier f (see element 225 of FIG. 2) parameterized by neural network weights θ. The standard expected risk minimization (ERM) approach seeks to learn θ by minimizing the in-domain risk measured by a suitable loss function such as the cross-entropy loss according to Equation 1, set forth below as follows:

$${ℛ}_{ERM} = {𝔼}_{x ∈ 𝒟} {ℒ}_{CE} ( f ( x ; θ ) , y ) .$$

For single-source domain generalization, of particular interest is a classifier f (225) that has the least risk on several unseen target domains [symbol] that are not observed during training. Experiments considered single-source domain generalization under covariate shift, e.g., when P(X) changes but P(Y|X) remains the same. ALT framework 200 builds on diversity based and adversarial augmentation approaches described below.

Generalization via Maximizing Diversity: A successful strategy to improve generalization on unseen domains is to utilize a set of predefined data augmentations [symbol] , to emphasize the invariance properties that are important for f(θ) to learn. Such methods modify Equation 1 above according to Equation 2, set forth below as follows:

$${ℛ}_{div} = {𝔼}_{x ∈ 𝒟} {ℒ}_{CE} ( f ( x ; θ ) , y ) + {λ}_{KL} {D}_{KL} ,$$

where D_{KL} is a consistency term, typically a divergence, such as KL-Divergence, between the softmax probabilities of classifier f (225) obtained with the clean and transformed data, respectively, e.g., D_{KL}=KL(f(x)∥f( [symbol] (x))).

The choice of [symbol] leads to different types of augmentations; for instance, AugMix utilizes a combination of predefined transformations such as shear, rotate, color jitter. Other approaches apply a randomly initialized convolutional layer to input image 139. Methods such as these are effective strategies to enforce diversity-based consistencies for generalization. Although these methods have the advantage of being simple predefined transformations that are dataset agnostic, they suffer from drawbacks under single-source domain generalization settings. When executed on their own, such a simplistic method may not capture sufficient diversity in terms of large semantic shifts, such as when expecting generalization on sketches from a model trained on photos.

Generalization via Adversarial Hardness: An alternative domain generalization approach is via adversarial augmentation which exposes classifier 225 to ‘hard’ samples during training—defined broadly as examples that are carefully designed to cause the model to fail. Such samples are augmented to the training set, with the expectation that exposure to such adversarial examples may improve the model's generalization performance on unseen domains. This is commonly enforced by learning an additive noise vector which when added, maximizes (e.g., increases) classifier 225 cost. Unfortunately, in the case of domain generalization, these methods have failed to match the performance of diversity-only methods optimizing for the cost outlined in Equation 2 above. This may be because they lack sufficient diversity, and by design, may only guarantee robustness to small perturbations from the training domain, as opposed to large semantic and stylistic shifts, which are beneficial for domain generalization.

ADVERSARIALLY LEARNED TRANSFORMATIONS (ALT): While diversity-only methods have shown promise, they are limited in their ability to generalize to domains with large shifts. Conversely, techniques based purely on adversarial hardness are theoretically well-motivated but do not match the performance of diversity-based methods.

Therefore, a mixed approach which takes the best of these two approaches utilizes adversary network 230 trained to create semantically consistent image transformations 226 that fool classifier 225. These manipulated images are then used during training as examples on which the image must learn invariance. Since these perturbations are parameterized as learnable weights of a neural network, the network is free to choose large and complex transformations (e.g., image transformations of varying size, varying complexity, or varying size and complexity including large and complex image transformations) without being restricted to additive noise as limited prior known techniques.

Moreover, ALT framework 200 may randomly initialize adversary network 230 for each batch, enabling the types of adversarial transformations 226 discovered by ALT framework 200 to be unique and diverse over the course of training.

Formally, adversary network g (see element 230 of FIG. 2) transforms input image 139 according to Equation 3, set forth below as follows:

$${x}_{g} = g ( x ) , where g \text{:} {ℝ}^{C \times H \times W} \to {ℝ}^{C \times H \times W} ,$$

where C, H, W represent the number of channels, height, and width of input images 139, respectively. The term g is parameterized by weights ϕ. This network, referred to herein as Adversarially Learned Transformations (ALT), forms the backbone of ALT framework 200.

To train an ALT model, an adversarial optimization problem was set up with the goal of producing transformations, which when applied to the source domain, may fool classifier f (225). While existing efforts dealing with robustness to small corruptions use [symbol] norm-bounded pixel-level perturbations to fool the model, this was found as not sufficient for domain generalization as such methods do not allow searching for adversarial samples with semantic changes. Instead, experiments directly performed adversarial training in the space of ϕ, e.g., the neural network weights of the ALT framework 200 model.

Given input images x (139), parameters ϕ are randomly initialized, and the corresponding adversarial samples x_{g} are found according to Equation 4, set forth below as follows:

$${x}_{g} = {max}_{ϕ} {ℒ}_{CE} ( f ( g ( x ; ϕ ) ; θ ) , y ) - {ℒ}_{TV} ( g ( x ; ϕ ) ) .$$

The first term seeks to update ϕ to maximize (e.g., increase) classifier 225 loss, while [symbol] (total variation) acts as a smoothness regularization for the generated image x_{g}=g(x; ϕ). The maximization in Equation 4 above is solved by performing m_{adv} steps of gradient descent with learning rate η_{adv}.

Unlike prior known techniques that explicitly place an [symbol] -norm constraint on the adversarial perturbations, experiments with ALT framework 200 controlled the strength of the adversarial examples by limiting the number of optimization steps taken by g to maximize or otherwise increase classification error. Next, experiments randomly initialized g for each batch to reset the networks of ALT framework 200 to a random function. In fact, when the number of adversarial steps was set to 0, adversary network g (230) behaves similar to RandConv since it is only a set of convolutional layers, with additional non-linearity.

Finally, in addition to limiting the number of adversarial steps, experiments with ALT framework 200 placed a simple total variation loss on the generated image to force smoothness in the output. This naturally suppresses high frequency noise-like artifacts and encourages realistic image transformations. The total variation loss placed on the generated image also prevented the optimization from resorting to learning trivial transformations in order to maximize or increase classifier f (225) loss, such as noise addition or entirely removing or obfuscating the semantic content of the image.

Improving Diversity: The samples x_{g} obtained by solving Equation 4 above represent hard adversarial images that may be leveraged by ALT framework 200 to generalize to domain shift. However, ALT framework 200 further lends itself to exploiting other forms of naïve diversity achieved by methods such as RandConv and AugMix.

These “diversity networks” 220 are represented by the term r, and produce outputs xᵣ=r(x). In some examples, ALT framework 200 utilizes these samples in the training process by enforcing joint consistency 215 between predictions 227 output by classifier 225 for source input image 139 and its transformations from diversity network r (220) and adversary network g (230). By including diversity network 220 within the optimization process, the invariances inferred by classifier 225 lead to stronger and more diverse adversarial examples in future epochs. Eventually, a synergistic partnership emerges between diversity network 220 and adversary network 230 to produce a wide range of image transformations that are significantly different from the source domain.

Let p_{c}, pᵣ and p_{g} denote the softmax prediction probabilities of classifier f (225) on x, xᵣ, and x_{g}, respectively. The consistency between these predictions may be computed using Kullback-Leibler divergence according to Equation 5, set forth below as follows:

$${ℒ}_{KL} = {D}_{KL} ( {p}_{mix} ‖ {p}_{c} ) + {w}_{r} {D}_{KL} ( {p}_{mix} ‖ {p}_{r} ) + ( 2 - {w}_{r} ) {D}_{KL} ( {p}_{mix} ‖ {p}_{g} ) ,$$

where the term pₘᵢₓ denotes the mixed prediction according to Equation 6, set forth below as follows:

$${p}_{mix} = \frac{{p}_{c} + {w}_{r} {p}_{r} + ( 2 - {w}_{r} ) {p}_{g}}{3} ,$$

The weight wᵣϵ[0,2] controls the relative contribution of diversity and adversity to the consistency loss. A result of wᵣ>1 implies more weight on consistency with diversity network 220. Conversely, a result of wᵣ<1 implies more weight on consistency with adversary network 230.

For experiments using ALT framework 200, wᵣ=1 was used, e.g., both diversity and adversary were given equal importance. A final loss function for training classifier 225 was given as the convex combination of the consistency [symbol] and classifier 225 loss [symbol] = [symbol] (f(g(x); θ), y), according to Equation 7, set forth below as follows:

$${ℒ}_{ALT} = ( 1 - {λ}_{KL} ) {ℒ}_{cls} + {λ}_{KL} {ℒ}_{KL} .$$

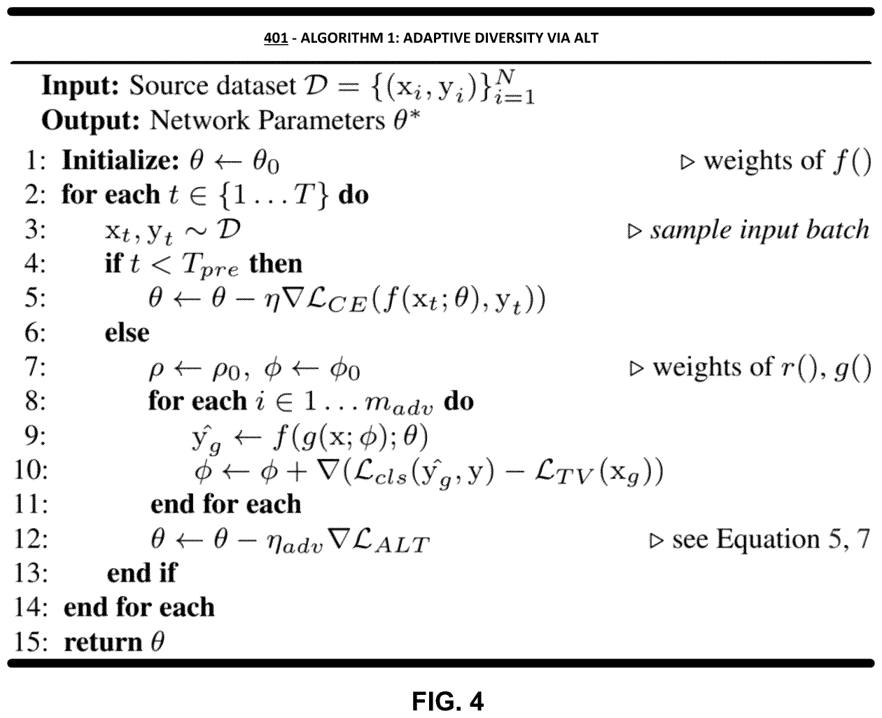

FIG. 4 depicts Algorithm 1 at element 401, providing pseudo code for applying adaptive diversity via ALT, in accordance with aspects of the disclosure.

In particular, Algorithm 1 (401) includes both an input and an output. Input into Algorithm 1 (401) is the source dataset,

$$𝒟 = {\{ ( {x}_{i} , {y}_{i} ) \}}_{i = 1}^{N} .$$

Output from Algorithm 1 (401) are the network parameters θ*.

Algorithm 1 (401) depicts an initialization stage with θ←θ₀, which are the weights of classifier f( ) (see element 225, FIG. 2).

Next, for each tϵ{1 . . . T}, Algorithm 1 (401) does the following: Evaluating a sample input batch xₜ, yₜ˜ [symbol] , if t<Tₚᵣₑ, then θ←θ−η∇ [symbol] (f(xₜ; θ), yₜ)), otherwise (else branch) the weights of r( ), g( ) are evaluated by ρ←ρ₀, ϕ←θ₀. Within the else branch, for each iϵ1 . . . m_{adv}, Algorithm 1 (401) does the following: Compute ŷ_{g}←f(g(x; ϕ); θ) and compute ϕ←ϕ+∇( [symbol] ( [symbol] , y)− [symbol] (x_{g})), at which point the for each sub-branch ends. Within the else branch, Algorithm 1 (401) computes θ←θ−η_{adv}∇ [symbol] according to Equations 5 and 7, at which point the if branch ends and the for each primary branch ends. Algorithm 1 (401) then returns θ as its output.

Implementation: In such a way, Algorithm 1 (401) shows an example implementation of ALT framework 200. In the experiments utilizing ALT framework 200, either RandConv or AugMix were used as diversity network r (220) and a fully-convolutional image-to-image network was utilized as adversary network g (230). In such experiments, adversary network g (230) had 5 convolutional layers with kernel size 3 and LeakyReLU activation. Experiments trained classifier f (225) for a total of T batch iterations of which Tₚᵣₑ iterations were used for pre-training classifier f (225) using standard ERM on only the source domain (e.g., with only [symbol] ).

During each of the batch iterations t>Tₚᵣₑ, experiments randomly initialized the weights of both diversity network r (220) and adversary network g (230) using a so-called “Kaiming Normal” strategy as the starting point for ALT framework 200 to produce diverse perturbations. Each batch iteration t>Tₚᵣₑ further updated adversary network g (230) using the adversarial cost set forth above by Equation 4. After adversary network g (230) was adversarially updated for the given batch iteration t>Tₚᵣₑ, experiments used the combination of classifier f (225) loss and the joint consistency 215 enforced according to Equation 7 described above to update model parameters θ.

FIG. 5 depicts Table 1 at element 501, illustrating single-source domain generalization accuracy (%) on PACS, in accordance with aspects of the disclosure.

Within Table 1, the term X→Y implies X is the source and Y is the target dataset. The term P indicates a photo; the term A indicates an art-painting; the term C indicates a cartoon; and the term S indicates sketch type image. Performance is reported as the mean of 5 repetitions.

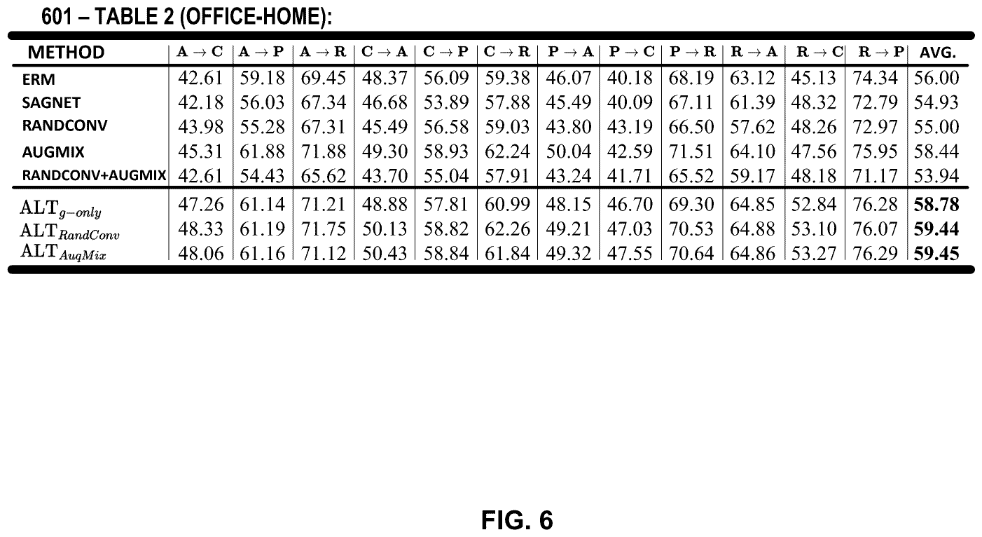

FIG. 6 depicts Table 2 at element 601, illustrating single-source domain generalization accuracy (%) on Office-Home, in accordance with aspects of the disclosure.

Within Table 2, the term X→Y implies X is the source and Y is the target dataset. The term R indicates the image is real; the term A indicates the image is art; the term C indicates the image is clipart; and the term P indicates the image is a product. Performance is reported as the mean of 5 repetitions.

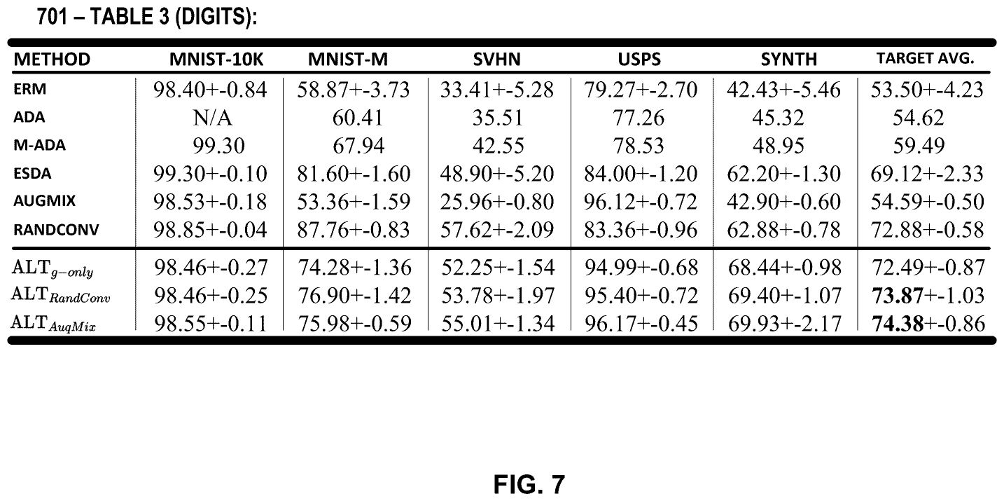

FIG. 7 depicts Table 3 at element 701, illustrating single-source domain generalization accuracy (%) on digit classification, with MNIST-10K as a source domain and MNIST-M, SVHN, USPS, and SYNTH as target domains, in accordance with aspects of the disclosure. Note that ADA and M-ADA do not report standard deviation.

EXPERIMENTS: Experiments validated ALT framework 200 with extensive empirical analysis of ALT and its constituent parts using three popularly used domain generalization benchmarks.

Datasets: The single source domain generalization experimental setup was as follows: Experiments trained an AI model on a single source domain utilizing ALT framework 200 and evaluated performance of the trained AI model on unobserved target domains 240 (or test images 241) without having any access whatsoever to any data from the target domains 240 (or test images 241) during training of the AI model. Stated differently, the target domains 240 (or test images 241) were never before seen images which formed no part of the training dataset from the source domain 235.

Benchmark datasets: Experiments demonstrated the effectiveness of ALT framework 200 using three popular domain generalization benchmark datasets:

PACS dataset: PACS, which includes images belonging to 7 classes from 4 domains (photo, art painting, cartoon, sketch), in which one domain was selected as the source domain 235 for the experiment and the rest of the image classes were selected as target domains 240.

Office-Home dataset: Office-Home includes images belonging to 65 classes from 4 domains (art, clipart, real, product). One domain was selected as the source domain 235 and the remaining image domains were selected as target domains 240.

Digits: Common settings were selected for the Digits benchmarking platform and the experiment used 1000 images from MNIST as the source domain 235 dataset, and USPS, SVHN, MNIST-M and SYNTH as the target domain 240 datasets.

Evaluation: For all datasets, experiments trained ALT framework 200 models on each individual source domain 235 separately and subsequently tested on the remaining target domains 240 enumerated above.

Fine-grained results are provided for each test set as well as the average domain generalization performance. A comparison is provided with several state-of-the-art techniques on single-source domain generalization and compared with three variants of ALT framework 200. In particular, ALT_{g-only} refers to ALT framework 200 that only uses adversary network g (230) during training without an explicit diversity network r (220). Variants of ALT framework 200 listed as ALT_{RandConv} and ALT_{AugMix} utilize RandConv and AugMix, respectively, as diversity network r (220), with joint consistency 215 now placed as explained above with respect to Equation 5.

### PACS—Table 1:

Baselines: ALT framework 200 baselines are JiGen, ADA, AugMix, RandConv, and SagNet—each designed to reduce style bias using normalization techniques. A combination of RandConv and AugMix was implemented—for instance, instead of ALT framework 200 using diversity network r (220) and adversary network g (230), two diversity networks r (220) were used (RandConv and AugMix) and the same joint consistency 215 was enforced as described with respect to Equation 5. This allows for a comparison of how effective adversary network g (230) was, compared to using two sources of diversity. Experiments used ResNet18 pre-trained on ImageNet as an architecture for ALT framework 200 model and trained all models for 2000 iterations with batch-size of 32, learning rate 0.004, SGD optimizer with cosine annealing learning rate scheduler, weight decay of 0.0001, and momentum 0.9. For the experiments, a consistency coefficient was set to λ_{KL}=0.75, adversarial learning rate was set to η_{adv}=5e−5, and number of adversarial steps was set to m_{adv}=10 and wᵣ=1.0.

Results: With reference to the results of Table 1 (501), it may be observed that ALT framework 200 without diversity network r (220) (e.g., ALT_{g-only}) surpasses generalization performance of all prior methods including diversity methods RandConv and AugMix and the previous best SagNet. ALT framework 200 with adaptive diversity further improves the results and ALT_{AugMix} establishes a new state-of-the-art accuracy of 64.7%. All three variants of ALT framework 200 are better than the combination of RandConv+AugMix, providing further evidence that adversarially learned transformations are more effective than combinations of diversity-based augmentations.

The Sketch (S) target domain (human drawn black-and-white sketches of real objects) has been the most difficult for prior known methods. Such difficulty may be observed in terms of performance in columns A→S, C→S, and P→S. ALT framework 200 significantly improved the performance on the sketch target domain. Generalizing from photos as source to C, S, A as targets is a very realistic setting, since large-scale natural image datasets such as ImageNet are widely used and publicly available, while data for sketches, cartoons, and paintings are limited. ALT framework 200 was the best performing model under this realistic setting.

### Office-Home—Table 2:

Baselines: For Office-Home, the protocol from the previous state-of-the-art SagNet model was utilized and ResNet50 was selected as the model architecture for ALT framework 200. The experiments did not perform any hyperparameter tuning for Office-Home and directly applied identical training settings and hyperparameters from PACS.

Results: With reference to Table 2 (601) depicting the results of the experiments on Office-Home, it may be observed that RandConv (previous best on Digits) and SagNet (previous best on PACS) performed worse than ERM on Office-Home, while AugMix was better by 2.44%. The combination of RandCon+AugMix was also worse than the ERM baseline. All three variants of ALT framework 200 surpassed prior results, with ALT_{AugMix} resulting in the best accuracy of 59.45%. The most difficult target domain for previous methods was Clipart (C), possibly because most clip-art images have white backgrounds, while real world photos (R) and product images are naturally occurring. ALT framework 200 improved performance in each case with C as the target domain 240. An observation similar to PACS may also be made here. Specifically, ALT framework 200 was the best model under the realistic setting of generalizing from widely available real photos (R) to other domains.

### Digits—Table 3:

Baselines: Baselines for ALT framework 200 included a naïve “source-only” model trained using expected risk minimization (ERM) on the source domain 235 dataset, M-ADA (an adversarial data augmentation method), and AugMix and RandConv which exploit diversity through consistency constraints. A comparison with ESDA is provided, an evolution-based search procedure over a predefined set of augmentations. DigitNet was used as the model architecture for all models for a fair comparison. All models were trained for T=10000 iterations, with batch-size of 32, learning rate of 0.0001, using the Adam optimizer. For ALT framework 200, the consistency coefficient was set to λ_{KL}=0.75, adversarial learning rate was set to η_{adv}=5e−6, number of adversarial steps m_{adv}=10, and an equal weight of wᵣ=1.0 was set for diversity network r (220) and adversary network g (230).

Results: With reference to FIG. 7, Table 3 (701) provides the results of experiments showing that pixel-level adversarial training approaches (ADA and M-ADA) offer only marginal improvements over the naïve ERM baseline.

The results for diversity-promoting data augmentation methods are mixed. While AugMix is only 1.09% better than ERM, RandConv provides a significant boost. Interestingly, the base version of ALT framework 200, ALT_{g-only}, which is exclusively based on adversarial training, is significantly better than pixel-level adversarial training. More importantly, it is also better than the diversity method AugMix, while performing lower than RandConv by a small margin of 0.39%. When experiments trained ALT framework 200 with adaptive diversity (ALT_{RandConv} and ALT_{AugMix}), the best performance was achieved by ALT framework 200, beating prior known state-of-the-art techniques.

The most difficult target domains 240 were SVHN and SYNTH as they contain real-world images of street signs and house number signs, whereas USPS is closely correlated with MNIST, both being black-and-white centered images of handwritten digits, and MNIST-M is derived from MNIST but with different backgrounds. AugMix fared poorly on both real-world datasets, but was able to generalize well to MNIST-M and USPS. Although AugMix results in an average accuracy of 54.59% on the target domains, when used in conjunction with ALT, the ALT_{AugMix} resulted in a large gain of 19.79%, highlighting the significance of adversary networks 230 within ALT framework 200.

### Analysis of ALT:

Various components of ALT framework 200 are described below, providing insights into their impact on generalization.

ALT is better than naïve diversity: ALT framework 200, even without an explicit diversity network r (220) module (e.g., ALT_{g-only}), still outperformed all the top performing methods across the benchmarks evaluated, indicating that learned adversarial transformations 226 are a powerful way to train classifiers 225 for generalization. ALT framework 200 may relegate the choice of diversity network 220 to being fairly arbitrary. The effect was observed on multiple benchmarks—for example, on the Digits benchmark shown in Table 3 (see element 701, FIG. 7), AugMix has a relatively poor generalization performance when compared with the baseline ERM, whereas ALT_{Augmix} achieved state-of-the-art performance thresholds. This is again seen in the Office-Home benchmark shown in Table 2 (see element 601, FIG. 6), where RandConv was worse than ERM, but ALT_{RandConv} was the best performing method. Thus, irrespective of the choice of diversity network r (220), the adversarially learned transformations 226 improved generalization on all benchmarks.

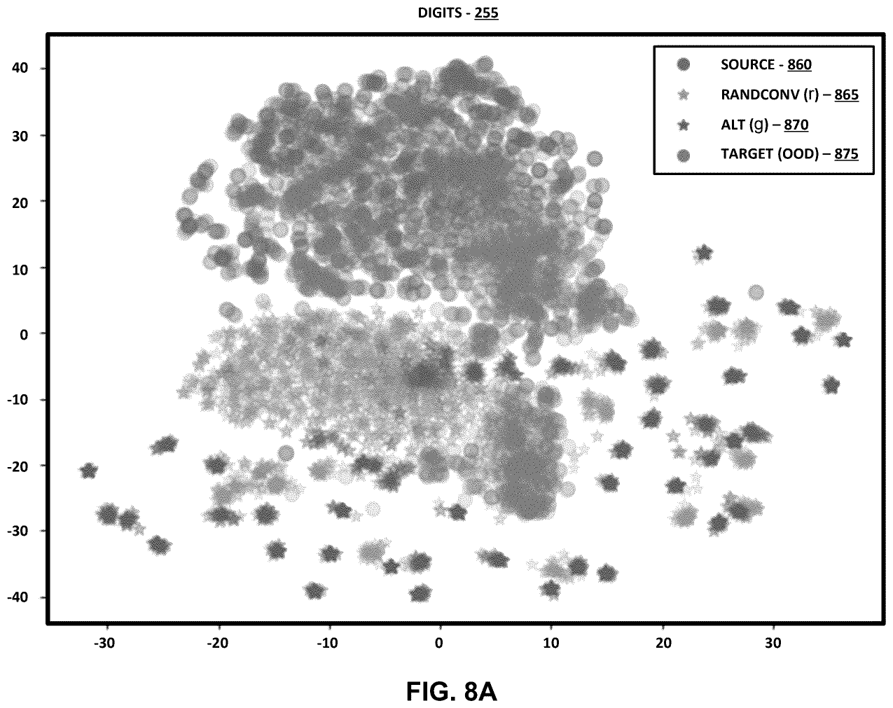

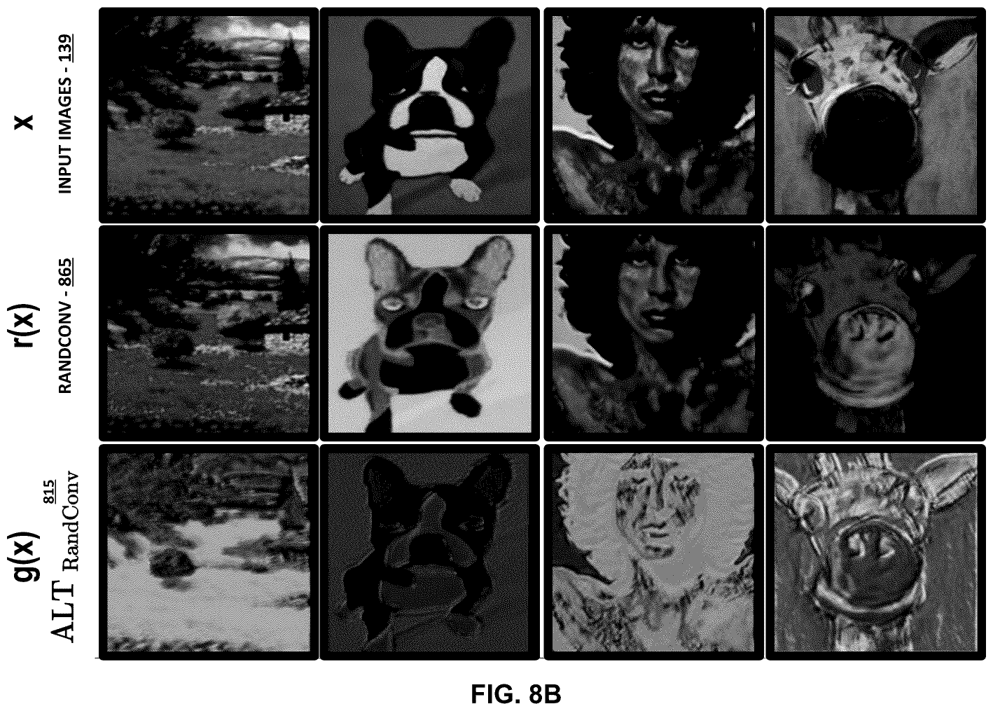

FIG. 8A illustrates a tSNE plot showing the discrepancy between the source 860 distribution (MNIST) and the target Out-Of-Distribution (OOD) 875 datasets for the “Digits” benchmark, in accordance with aspects of the disclosure. More particularly, the tSNE plot shows that diversity introduced by ALT (g) 870, as implemented by ALT framework 200, is much larger and wide-spread than data augmentation techniques such as RandConv (r) 865.

In FIG. 8A, the tSNE plot shows the diversity introduced by ALT (g) 870 on the Digits benchmark and analyzed in comparison to the source distribution the target (OOD) 875 distribution and the distribution of RandConv (r) 865 augmentations. While RandConv (r) 865 does simulate a domain shift compared to the source, most RandConv (r) 865 points are clustered close to each other. However, the diversity due to application of ALT (g) 870 by ALT framework 200 is considerably larger and resulting samples from ALT (g) 870 are spread widely across the tSNE space.

Such results may be due to data augmentation functions have a fixed types of diversity (random convolution filter in the case of ALT framework 200), while ALT (g) 870 may search for adversarial transformations 226 for each batch, leading to novel types of diversity for each batch of training samples.

FIG. 8B provides a qualitative comparison of PACS images transformed by RandConv (r) 865 data augmentation vs. ALT framework 200 (ALT_{RandConv} 815), illustrating the wide range of transformations learned by ALT framework 200, in accordance with aspects of the disclosure.

Qualitative examples of the image transformations 226 learned with ALT framework 200 are depicted. It is clear from the qualitative examples that ALT framework 200, applying ALT_{RandConv} 815, achieves far more diverse and larger transformations 226 of input images 139 than previous data augmentation techniques.

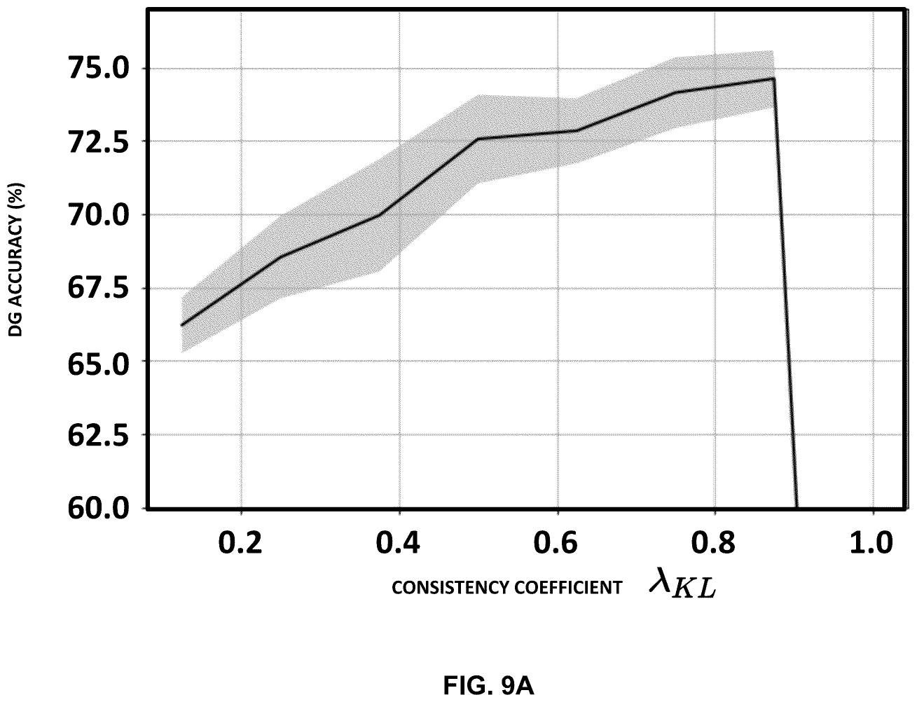

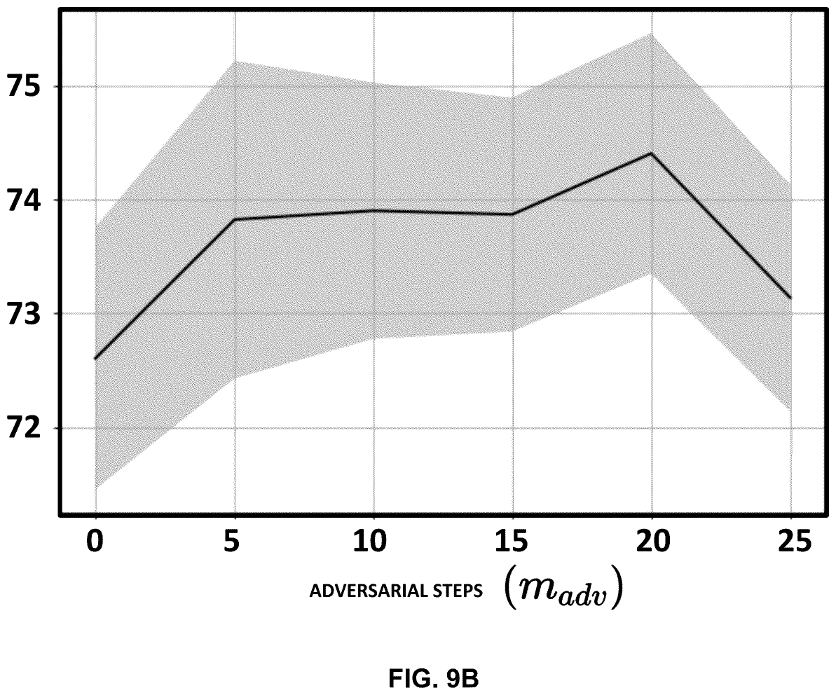

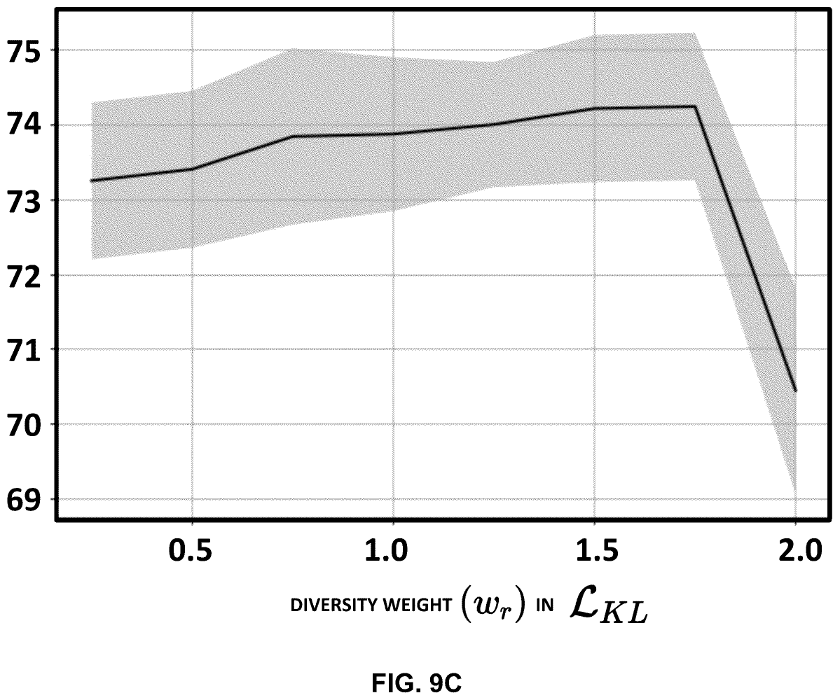

FIGS. 9A, 9B, and 9C provide analysis depicting the effect of each hyper-parameter in ALT framework 200 on the average accuracy using the Digits benchmark, in accordance with aspects of the disclosure. Each hyper-parameter is shown as 1 standard deviation around the mean over 5 runs.

Effect of Varying ALT Hyperparameters: The three main hyper-parameters that control application of the disclosed methodology by ALT framework 200 include: (1) hyper-parameter λ_{KL}, which is the coefficient in from Equation 5 above used for deciding (programmatically selecting) the weight for the KL-divergence consistency in the total loss. (2) Hyper-parameter m_{adv}, which is the number of adversarial steps in the adversarial maximization of Equation 3 described above. And (3) hyper-parameter wᵣ, which is the diversity weight for controlling (e.g., configuring) the interaction between diversity network r( ) (see element 220, FIG. 2) and adversary network g( ) (see element 230, FIG. 2) in Equation 6 described above.

The effects of diversity network r( ) and adversary network go was investigated on domain generalization accuracy in FIGS. 9A, 9B, and 9C.

FIG. 9A depicts that consistency is generally important until a certain point, after which it becomes harmful. Specifically, the plot of FIG. 9A shows that the consistency coefficient λ_{KL} is impactful and a higher value leads to better generalization. However at λ_{KL}=1.0, the accuracy degenerates to random performance. This is expected as loss of classifier f (see element 225, FIG. 2) gets a weight of 1−λ_{KL}=0.

FIG. 9B depicts that taking more adversarial steps improves performance. Specifically, the plot of FIG. 9B shows that the optimal number of adversarial steps is around 20. Note that performance at all non-zero values of mad that were evaluated via the experiments (including non-zero values 5, 10, 15, 20, 25) were greater than previous state-of-the-art results.

FIG. 9C depicts that, unexpectedly, the trade-off between diversity and adversity is found to be non-trivial and dataset dependent. In experiments using ALT framework 200 for benchmarking (see Tables 1, 2, 3 at FIGS. 5, 6, and 7) no hyper-parameter tuning was performed and an equal weight of wᵣ=1 was set to each of adversity and diversity. Specifically, the importance of adversary network g (230) module is made evident from the plot of FIG. 9C shows which shows performance at wᵣ=0 for the adversary network g (230) module only results in higher performance than a weight of wᵣ=2 for the diversity network r (220) module only. Moreover, the combination of both adversary network g (230) and diversity network r (220) modules yields the best results overall, making it clear that adversary network g (230) component correlates unambiguously with improvements in generalization.

In such a way, the problem of Single Source Domain Generalization (SSDG) is addressed through the utilization of ALT framework 200 and application of the described methodologies set forth herein. For instance, ALT framework 200 enables updates to a convolutional network to learn plausible image transformations 226 of source domain 235 that may fool classifier f (225) during training. ALT framework 200 enables the enforcement of joint consistency 215 constraints on predictions 227 by classifier f (225) on clean images and transformed images. ALT framework 200 provides significant improvements over prior known techniques that utilize pixel-wise perturbations. Experiments utilizing ALT framework 200 demonstrably outperformed all existing techniques, including standard data augmentation methods, on multiple benchmarks as ALT framework 200 enables the generation of a diverse set of large transformations of the source domain 235. ALT framework 200 may be readily combined with existing diversity networks 220 such as RandConv or AugMix to improve their performance.

Experiments further evaluated ALT framework 200 components through extensive ablations and analysis to obtain insights into the performance gains demonstrated by ALT framework 200. The ablation and analysis indicate that naïve diversity alone is insufficient to maximize or sufficiently increase generalization performance. Rather, improved generalization performance may be attained through the combination of adversarially learned transformations 226, as is done by ALT framework 200, to yield maximized (e.g., increased) generalization performance sufficient to establish new state-of-the-art performance levels.

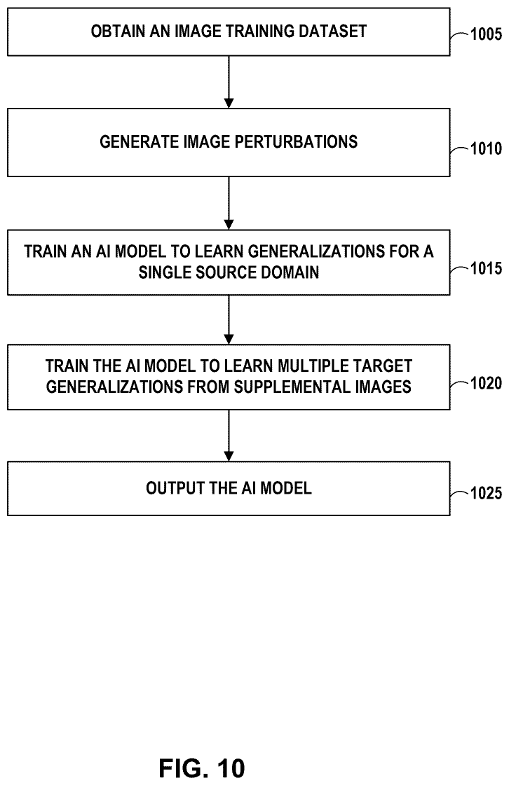

FIG. 10 is a flow chart illustrating an example mode of operation for computing device 100 to improve diversity using adversarially learned transformations for domain generalization, in accordance with aspects of the disclosure. The mode of operation is described with respect to computing device 100 and FIGS. 1, 2, 3, 4, 5, 6, 7, 8A, 9B, 9A, 9B, and 9C.

Computing device 100 may obtain a training dataset (1005) by which to train an AI model. For instance, processing circuitry may execute an Adversarially Learned Transformations framework (ALT framework) to learn multiple target generalizations from a single source domain. In such an example, the ALT framework may include a diversity network, an adversary network, and a classifier. Computing device 100 may obtain, by the processing circuitry, an image training dataset having a plurality of input images representing the single source domain.

Computing device 100 may generate image perturbations (1010). For example, processing circuitry 199 of computing device 100 may generate, utilizing the AFT framework, image perturbations parameterized by the adversarial network as learnable weights of a neural network representing learned image transformations by the adversarial network for the plurality of input images.

Computing device 100 may train an Artificial Intelligence model (AI model) to learn generalizations for a single source domain (1015). For example, processing circuitry 199 of computing device 100 may train an AI model of the AFT framework to learn generalizations for the single source domain from the plurality of input images of the image training dataset and the learnable weights of the neural network representing the learned image transformations by the adversarial network.

Computing device 100 may train the AI model to learn multiple target generalizations from supplemental images (1020). For example, processing circuitry 199 of computing device 100 may train the AI model of the AFT framework to learn the multiple target generalizations from supplemental images generated by the adversarial network.

Computing device 100 may output the AI model (1025). For example, processing circuitry 199 of computing device 100 may output the AI model having been trained to learn the generalization for multiple target domains from a single source domain.

According to another example, computing device 100 may learn, by the processing circuitry utilizing the ALT framework, image transformations from the adversary network determined to result in a failed prediction output by the classifier. In response to a determination the image from the adversary network results in the failed prediction output by the classifier, computing device 100 may supplement, by the processing circuitry utilizing the ALT framework, the image training dataset with new images using at least the image transformations from the adversary network determined to result in the failed prediction output by the classifier.

According to another example of computing device 100, the AI model is a trained AI model generalized to multiple target domains utilizing the multiple target generalizations learned from the single source domain.

According to another example, computing device 100 may generate, by the processing circuitry utilizing the AFT framework, the supplemental images from the adversarial network based on the image perturbations. According to such an example, the supplemental images form no part of the image training dataset obtained.

According to another example, computing device 100 may generate, by the processing circuitry utilizing the adversarial network of the AFT framework, the supplemental images configured to trigger the AI model having learned the generalizations for the single source domain to output a failed classification prediction.

According to another example, computing device 100 may train, by the processing circuitry, the AI model of the AFT framework to learn increased generalizations to unseen domains which form no part of the image training dataset obtained, wherein the multiple target generalizations form at least a portion of the increased generalizations to the unseen domains learned by the AI model.

According to another example, computing device 100 may supplement, by the processing circuitry utilizing the ALT framework, the image training dataset with new image transformations derived from images within the image training dataset utilizing data augmentation operations.

According to another example, computing device 100 may generate, by the processing circuitry utilizing the AFT framework, the learnable weights of the neural network based at least in part on large and complex transformations by the adversary network to the plurality of input images of the image training dataset without use of additive noise. In such examples, computing device 100 may generate, by the processing circuitry utilizing the ALT framework, the learnable weights of the neural network for the plurality of input images of the image training dataset using image transformations of varying size, varying complexity, or varying size and varying complexity.

For processes, apparatuses, and other examples or illustrations described herein, including in any flowcharts or flow diagrams, certain operations, acts, steps, or events included in any of the techniques described herein may be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may include RAM, ROM, EEPROM, CD-ROM or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A system comprising:
processing circuitry; and
non-transitory computer readable media storing instructions that, when executed by the processing circuitry, configure the processing circuitry to:
execute, by the processing circuitry, an Adversarially Learned Transformations framework (ALT framework) to learn multiple target generalizations from a single source domain, the ALT framework having at least a diversity network, an adversary network, and a classifier;
obtain, by the processing circuitry, an image training dataset having a plurality of input images representing the single source domain;
generate, by the processing circuitry utilizing the ALT framework, image perturbations parameterized by the adversarial network as learnable weights of a neural network representing learned image transformations by the adversarial network for the plurality of input images;
train, by the processing circuitry, an Artificial Intelligence model (AI model) of the ALT framework to learn generalizations for the single source domain from the plurality of input images of the image training dataset and the learnable weights of the neural network representing the learned image transformations by the adversarial network;
train, by the processing circuitry, the AI model of the ALT framework to learn the multiple target generalizations from supplemental images generated by the adversarial network; and
output, by the processing circuitry, the AI model.

2. The system of claim 1, wherein the processing circuitry is further configured to:
learn, by the processing circuitry utilizing the ALT framework, image transformations from the adversary network determined to result in a failed prediction output by the classifier; and
responsive to a determination the image transformations from the adversary network results in the failed prediction output by the classifier, supplement, by the processing circuitry utilizing the ALT framework, the image training dataset with new images using at least the image transformations from the adversary network determined to result in the failed prediction output by the classifier.

3. The system of claim 1:
wherein the AI model is a trained AI model generalized to multiple target domains utilizing the multiple target generalizations learned from the single source domain.

4. The system of claim 1, wherein the processing circuitry is further configured to:
generate, by the processing circuitry utilizing the ALT framework, the supplemental images from the adversarial network based on the image perturbations; and
wherein the supplemental images form no part of the image training dataset obtained.

5. The system of claim 1, wherein the processing circuitry is further configured to:
generate, by the processing circuitry utilizing the adversarial network of the ALT framework, the supplemental images configured to trigger the AI model having learned the generalizations for the single source domain to output a failed classification prediction; and
train, by the processing circuitry, the AI model of the ALT framework to learn increased generalizations to unseen domains which form no part of the image training dataset obtained, wherein the multiple target generalizations form at least a portion of the increased generalizations to the unseen domains learned by the AI model.

6. The system of claim 1, wherein the processing circuitry is further configured to:
supplement, by the processing circuitry utilizing the ALT framework, the image training dataset with new image transformations derived from images within the image training dataset utilizing data augmentation operations.

7. The system of claim 1, wherein the processing circuitry is further configured to:
generate, by the processing circuitry utilizing the ALT framework, the learnable weights of the neural network by the adversary network for the plurality of input images of the image training dataset without use of additive noise; and
wherein the adversary network generates the learnable weights of the neural network for the plurality of input images of the image training dataset using image transformations of varying size, varying complexity, or varying size and varying complexity.

8. A method comprising:
executing, by one or more processors of a computing device, an Adversarially Learned Transformations framework (ALT framework) to learn multiple target generalizations from a single source domain, the ALT framework having at least a diversity network, an adversary network, and a classifier;
obtaining, by the one or more processors, an image training dataset having a plurality of input images representing the single source domain;
generating, by the one or more processors utilizing the ALT framework, image perturbations parameterized by the adversarial network as learnable weights of a neural network representing learned image transformations by the adversarial network for the plurality of input images;
training, by the one or more processors, an Artificial Intelligence model (AI model) of the ALT framework to learn generalizations for the single source domain from the plurality of input images of the image training dataset and the learnable weights of the neural network representing the learned image transformations by the adversarial network;
training, by the one or more processors, the AI model of the ALT framework to learn the multiple target generalizations from supplemental images generated by the adversarial network; and
outputting, by the one or more processors, the AI model.

9. The method of claim 8, further comprising:
learning, by the one or more processors utilizing the ALT framework, image transformations from the adversary network determined to result in a failed prediction output by the classifier; and
responsive to a determination the image transformations from the adversary network results in the failed prediction output by the classifier, supplementing, by the one or more processors utilizing the ALT framework, the image training dataset with new images using at least the image transformations from the adversary network determined to result in the failed prediction output by the classifier.

10. The method of claim 8:
wherein the AI model is a trained AI model generalized to multiple target domains utilizing the multiple target generalizations learned from the single source domain.

11. The method of claim 8, further comprising:
generating, by the one or more processors utilizing the ALT framework, the supplemental images from the adversarial network based on the image perturbations; and
wherein the supplemental images form no part of the image training dataset obtained.

12. The method of claim 8, further comprising:
generating, by the one or more processors utilizing the adversarial network of the ALT framework, the supplemental images configured to trigger the AI model having learned the generalizations for the single source domain to output a failed classification prediction; and
training, by the one or more processors, the AI model of the ALT framework to learn increased generalizations to unseen domains which form no part of the image training dataset obtained, wherein the multiple target generalizations form at least a portion of the increased generalizations to the unseen domains learned by the AI model.

13. The method of claim 8, further comprising:
supplementing, by the one or more processors utilizing the ALT framework, the image training dataset with new image transformations derived from images within the image training dataset utilizing data augmentation operations.

14. The method of claim 8, further comprising:
generating, by the one or more processors utilizing the ALT framework, the learnable weights of the neural network by the adversary network for the plurality of input images of the image training dataset without use of additive noise; and
wherein the adversary network generates the learnable weights of the neural network for the plurality of input images of the image training dataset using image transformations of varying size, varying complexity, or varying size and varying complexity.

15. Computer-readable storage media storing instructions that, when executed, configure processing circuitry to:
execute an Adversarially Learned Transformations framework (ALT framework) to learn multiple target generalizations from a single source domain, the ALT framework having at least a diversity network, an adversary network, and a classifier;
obtain an image training dataset having a plurality of input images representing the single source domain;
generate, utilizing the ALT framework, image perturbations parameterized by the adversarial network as learnable weights of a neural network representing learned image transformations by the adversarial network for the plurality of input images;
train an Artificial Intelligence model (AI model) of the ALT framework to learn generalizations for the single source domain from the plurality of input images of the image training dataset and the learnable weights of the neural network representing the learned image transformations by the adversarial network;
train the AI model of the ALT framework to learn the multiple target generalizations from supplemental images generated by the adversarial network; and
output the AI model.

16. The computer-readable storage media comprising of claim 15, wherein the processing circuitry is further configured to:
learn, utilizing the ALT framework, image transformations from the adversary network determined to result in a failed prediction output by the classifier; and
responsive to a determination the image transformations from the adversary network results in the failed prediction output by the classifier, supplement, utilizing the ALT framework, the image training dataset with new images using at least the image transformations from the adversary network determined to result in the failed prediction output by the classifier.

17. The computer-readable storage media comprising of claim 15:
wherein the AI model is a trained AI model generalized to multiple target domains utilizing the multiple target generalizations learned from the single source domain.

18. The computer-readable storage media comprising of claim 15, wherein the processing circuitry is further configured to:
generate, utilizing the ALT framework, the supplemental images from the adversarial network based on the image perturbations; and
wherein the supplemental images form no part of the image training dataset obtained.

19. The computer-readable storage media comprising of claim 15, wherein the processing circuitry is further configured to:
generate, utilizing the adversarial network of the ALT framework, the supplemental images configured to trigger the AI model having learned the generalizations for the single source domain to output a failed classification prediction; and
train the AI model of the ALT framework to learn increased generalizations to unseen domains which form no part of the image training dataset obtained, wherein the multiple target generalizations form at least a portion of the increased generalizations to the unseen domains learned by the AI model.

20. The computer-readable storage media comprising of claim 15, wherein the processing circuitry is further configured to:
supplement, utilizing the ALT framework, the image training dataset with new image transformations derived from images within the image training dataset utilizing data augmentation operations.
